(19) United States
(12) Patent Application Publication
(10) Pub. No.: US 2024/0142623 A1
(43) Pub. Date: May 2, 2024

(54) DOPPLER PROCESSING IN COHERENT LIDAR

(71) Applicant: Analog Photonics LLC, Boston, MA (US)

(72) Inventors: Peter Nicholas Russo, Arlington, MA (US); Michael Robert Watts, Hingham, MA (US); Matthew Byrd, Arlington, MA (US)

(73) Assignee: Analog Photonics LLC, Boston, MA (US)

(21) Appl. No.: 18/495,855

(22) Filed: Oct. 27, 2023

Related U.S. Application Data
(60) Provisional application No. 63/420,070, filed on Oct. 27, 2022.

(51) Int. Cl. G01S 17/34; G01S 7/481; G01S 17/58

(52) U.S. Cl. CPC G01S 17/34; G01S 7/4811; G01S 17/58

(57) ABSTRACT

Modulation of a frequency of a transmitted optical wave includes: at least a first and second slopes for respective frequency sweeps associated with respective points in at least one of a first or second frame. A computed range and a computed velocity are determined based on combining first partial data derived from at least one measurement associated with a first backscattered portion of the transmitted optical wave with second partial data derived from at least one measurement associated with a second backscattered portion of the transmitted optical wave. The first backscattered portion is received during a frequency sweep at the first slope associated with a first point in the first frame. The second backscattered portion is received during a frequency sweep at the second slope associated with a second point in the first frame different from the first point or associated with at least one point in the second frame.

### CROSS-REFERENCE TO RELATED APPLICATION(S)

This application claims the benefit of and priority to U.S. Provisional Application Ser. No. 63/420,070, entitled “DOPPLER PROCESSING IN COHERENT LIDAR,” filed Oct. 27, 2022, which is incorporated herein by reference.

### TECHNICAL FIELD

This disclosure relates to Doppler processing in coherent LiDAR.

### BACKGROUND

Some LiDAR systems optimize various aspects of the LiDAR configuration based on different criteria. An optical wave is transmitted from an optical source to target object(s) at a given distance and the light backscattered from the target object(s) is collected. Some optical phased arrays (OPAs) used in such systems have a linear distribution of emitter elements (also called emitters or antennas). Steering about a first axis perpendicular to the linear distribution can be provided by changing the relative phase shifts in phase shifters feeding each of the emitter elements. Other techniques can be used for steering about a second axis orthogonal to the first axis. In a coherent LiDAR system the collected light is combined with a local oscillator (LO) that is coherent with the transmitted optical wave. The optical source used in such a system is typically a laser, which provides an optical wave that has as narrow linewidth and has a peak wavelength that falls in a particular range (e.g., between about 100 nm to about 1 mm, or some subrange thereof), also referred to herein as simply “light.”

### SUMMARY

In one aspect, in general, an apparatus comprises: an optical transmitter configured to provide a beam of a transmitted optical wave scanned over a series of points arranged over a region, where the scanning over the series of points is repeated for each of a plurality of frames; an optical receiver configured to receive backscattered portions of the transmitted optical wave and determine measurements associated with the backscattered portions of the transmitted optical wave for each of a plurality of the series of points for each of a plurality of the plurality of frames; and a frequency modulation controller configured to control modulation of a frequency of the transmitted optical wave, where the modulation of the frequency of the transmitted optical wave includes, for a first frame of the plurality of frames and a second frame of the plurality of frames: at least a first slope for each of a plurality of frequency sweeps associated with respective points in at least one of the first or second frame, and at least a second slope, different from the first slope, for each of a plurality of frequency sweeps associated with respective points in at least one of the first or second frame, wherein a set of all frequency sweeps for the first frame consists of fewer than two different frequency sweeps for each point in the series of points; and a data combination module configured to determine at least one computed range and at least one computed velocity based at least in part on combining (1) first partial data derived from at least one measurement associated with a first backscattered portion of the transmitted optical wave with (2) second partial data derived from at least one measurement associated with a second backscattered portion of the transmitted optical wave, where: the first backscattered portion of the transmitted optical wave is received by the optical receiver during a frequency sweep at the first slope associated with a first point in the first frame, and the second backscattered portion of the transmitted optical wave is received by the optical receiver during a frequency sweep at the second slope associated with a second point in the first frame different from the first point or associated with at least one point in the second frame.

Aspects can include one or more of the following features.

The set of all frequency sweeps for the first frame consist of frequency sweeps having the first slope, and a set of all frequency sweeps for the second frame consist of frequency sweeps having the second slope.

A frequency sweep for each point in the first frame has a slope that is different from a slope of a frequency sweep for that point in the second frame.

At least one point in the second frame is skipped based at least in part on a measurement associated with that point in the first frame.

The set of all frequency sweeps for the first frame are not identical to a set of all frequency sweeps for the second frame.

The second slope has an identical magnitude and opposite sign from the first slope.

Both the first slope and the second slope are nonzero.

The data combination module is further configured to determine the at least one computed range and the at least one computed velocity based at least in part on a third backscattered portion of the transmitted optical wave received by the optical receiver during a frequency sweep at a third slope associated with at least one point in a third frame.

In another aspect, in general, a method comprises: providing, by an optical transmitter, a beam of a transmitted optical wave scanned over a series of points arranged over a region, where the scanning over the series of points is repeated for each of a plurality of frames; receiving, by an optical receiver, backscattered portions of the transmitted optical wave and determine measurements associated with the backscattered portions of the transmitted optical wave for each of a plurality of the series of points for each of a plurality of the plurality of frames; and controlling, by a frequency modulation controller, modulation of a frequency of the transmitted optical wave, where the modulation of the frequency of the transmitted optical wave includes, for a first frame of the plurality of frames and a second frame of the plurality of frames: at least a first slope for each of a plurality of frequency sweeps associated with respective points in at least one of the first or second frame, and at least a second slope, different from the first slope, for each of a plurality of frequency sweeps associated with respective points in at least one of the first or second frame, wherein a set of all frequency sweeps for the first frame consists of fewer than two different frequency sweeps for each point in the series of points; and determining, by a data combination module, at least one computed range and at least one computed velocity based at least in part on combining (1) first partial data derived from at least one measurement associated with a first backscattered portion of the transmitted optical wave with (2) second partial data derived from at least one measurement associated with a second backscattered portion of the transmitted optical wave, where: the first backscattered portion of the transmitted optical wave is received by the optical receiver during a frequency sweep at the first slope associated with a first point in the first frame, and the second backscattered portion of the transmitted optical wave is received by the optical receiver during a frequency sweep at the second slope associated with a second point in the first frame different from the first point or associated with at least one point in the second frame.

Aspects can include one or more of the following features.

The set of all frequency sweeps for the first frame consist of frequency sweeps having the first slope, and a set of all frequency sweeps for the second frame consist of frequency sweeps having the second slope.

A frequency sweep for each point in the first frame has a slope that is different from a slope of a frequency sweep for that point in the second frame.

At least one point in the second frame is skipped based at least in part on a measurement associated with that point in the first frame.

The set of all frequency sweeps for the first frame are not identical to a set of all frequency sweeps for the second frame.

The second slope has an identical magnitude and opposite sign from the first slope.

Both the first slope and the second slope are nonzero.

The method further comprises determining the at least one computed range and the at least one computed velocity based at least in part on a third backscattered portion of the transmitted optical wave received by the optical receiver during a frequency sweep at a third slope associated with at least one point in a third frame.

In another aspect, in general, an apparatus comprises: an optical transmitter configured to provide a beam of a transmitted optical wave scanned over a series of points arranged over a region; an optical receiver configured to receive backscattered portions of the transmitted optical wave and determine measurements associated with the backscattered portions of the transmitted optical wave for each of a plurality of the series of points, wherein the measurements include measurements used to determine at least one computed range and at least one computed velocity; and a phase modulation controller configured to control modulation of a phase of the transmitted optical wave, where the modulation of the phase of the transmitted optical wave includes, for each of a plurality of the points in the series of points: a first time period in which there is a constant phase, and a second time period in which there is a non-constant phase modulated between at least two different phases.

Aspects can include one or more of the following features.

For each of the plurality of the points in the series of points, an amplitude of the transmitted optical wave is constant during the second time period in which there is a non-constant phase modulated between at least two different phases.

An amplitude of the transmitted optical wave is constant over an entire time period over all of the plurality of points in the series of points.

In another aspect, in general, a method comprises: providing, by an optical transmitter, a beam of a transmitted optical wave scanned over a series of points arranged over a region; receiving, by an optical receiver, backscattered portions of the transmitted optical wave and determine measurements associated with the backscattered portions of the transmitted optical wave for each of a plurality of the series of points, wherein the measurements include measurements used to determine at least one computed range and at least one computed velocity; and controlling, by a phase modulation controller, modulation of a phase of the transmitted optical wave, where the modulation of the phase of the transmitted optical wave includes, for each of a plurality of the points in the series of points: a first time period in which there is a constant phase, and a second time period in which there is a non-constant phase modulated between at least two different phases.

Aspects can include one or more of the following features.

For each of the plurality of the points in the series of points, an amplitude of the transmitted optical wave is constant during the second time period in which there is a non-constant phase modulated between at least two different phases.

An amplitude of the transmitted optical wave is constant over an entire time period over all of the plurality of points in the series of points.

In another aspect, in general, an apparatus comprises: an optical transmitter configured to provide a beam of a transmitted optical wave scanned over a series of points arranged over a region, where the scanning over the series of points is repeated for each of a plurality of frames; an optical receiver configured to receive backscattered portions of the transmitted optical wave and determine measurements associated with the backscattered portions of the transmitted optical wave for each of a plurality of the series of points for each of a plurality of the plurality of frames; a modulation controller configured to control modulation of the transmitted optical wave; and a computing module configured to compute at least one computed range and at least one computed velocity based at least in part on measurements associated with the backscattered portions of the transmitted optical wave, where the computing comprises: determining the computed velocity based at least in part on a frequency shift associated with a Doppler frequency measurement associated with a backscattered portion of the transmitted optical wave, and determining the computed range based at least in part on a first matched filter that is based at least in part on (1) a portion of modulation applied by the modulation controller and (2) the frequency shift associated with the Doppler frequency measurement.

Aspects can include one or more of the following features.

The modulation controller comprises a phase modulation controller configured to control modulation of a phase of the transmitted optical wave, and the portion of modulation applied by the modulation controller comprises a portion of phase modulation applied by the modulation controller.

The Doppler frequency measurement is determined at least in part by determining a Fourier transform of a first electrical signal associated with the backscattered portion of the transmitted optical wave.

The first electrical signal is associated with the backscattered portion of the transmitted optical wave during a first time period in which there is a constant phase.

The first matched filter is applied to a second electrical signal associated with the backscattered portion of the transmitted optical wave during a second time period in which there is a non-constant phase modulated between at least two different phases.

The Doppler frequency measurement is determined based at least in part on a second matched filter that is based at least in part on a Fourier transform of the portion of modulation applied by the modulation controller.

In another aspect, in general, a method comprises: providing, by an optical transmitter, a beam of a transmitted optical wave scanned over a series of points arranged over a region, where the scanning over the series of points is repeated for each of a plurality of frames; receiving, by an optical receiver, backscattered portions of the transmitted optical wave and determine measurements associated with the backscattered portions of the transmitted optical wave for each of a plurality of the series of points for each of a plurality of the plurality of frames; controlling, by a modulation controller, modulation of the transmitted optical wave; and computing, by a computing module, at least one computed range and at least one computed velocity based at least in part on measurements associated with the backscattered portions of the transmitted optical wave, where the computing comprises: determining the computed velocity based at least in part on a frequency shift associated with a Doppler frequency measurement associated with a backscattered portion of the transmitted optical wave, and determining the computed range based at least in part on a first matched filter that is based at least in part on (1) a portion of modulation applied by the modulation controller and (2) the frequency shift associated with the Doppler frequency measurement.

Aspects can include one or more of the following features.

The modulation controller comprises a phase modulation controller configured to control modulation of a phase of the transmitted optical wave, and the portion of modulation applied by the modulation controller comprises a portion of phase modulation applied by the modulation controller.

The Doppler frequency measurement is determined at least in part by determining a Fourier transform of a first electrical signal associated with the backscattered portion of the transmitted optical wave.

The first electrical signal is associated with the backscattered portion of the transmitted optical wave during a first time period in which there is a constant phase.

The first matched filter is applied to a second electrical signal associated with the backscattered portion of the transmitted optical wave during a second time period in which there is a non-constant phase modulated between at least two different phases.

The Doppler frequency measurement is determined based at least in part on a second matched filter that is based at least in part on a Fourier transform of the portion of modulation applied by the modulation controller.

In another aspect, in general, an apparatus comprises: an optical transmitter configured to provide a beam of a transmitted optical wave scanned over a series of points arranged over a region, where the scanning over the series of points is repeated for each of a plurality of frames; an optical receiver configured to receive backscattered portions of the transmitted optical wave and determine measurements associated with the backscattered portions of the transmitted optical wave for each of a plurality of the series of points for each of a plurality of the plurality of frames; a modulation controller configured to control modulation of the transmitted optical wave; and a computing module configured to compute at least one computed range and at least one computed velocity based at least in part on measurements associated with the backscattered portions of the transmitted optical wave, where the computing comprises: determining the computed velocity based at least in part on a first matched filter that is based at least in part on a frequency domain representation of a modulation applied by the modulation controller, and determining the computed range based at least in part on a second matched filter that is based at least in part on a time domain representation of the modulation applied by the modulation controller.

Aspects can include the following feature.

The modulation controller comprises a phase modulation controller configured to control modulation of a phase of the transmitted optical wave.

In another aspect, in general, a method comprises: providing, by an optical transmitter, a beam of a transmitted optical wave scanned over a series of points arranged over a region, where the scanning over the series of points is repeated for each of a plurality of frames; receiving, by an optical receiver, backscattered portions of the transmitted optical wave and determine measurements associated with the backscattered portions of the transmitted optical wave for each of a plurality of the series of points for each of a plurality of the plurality of frames; controlling, by a modulation controller, modulation of the transmitted optical wave; and computing, by a computing module, at least one computed range and at least one computed velocity based at least in part on measurements associated with the backscattered portions of the transmitted optical wave, where the computing comprises: determining the computed velocity based at least in part on a first matched filter that is based at least in part on a frequency domain representation of a modulation applied by the modulation controller, and determining the computed range based at least in part on a second matched filter that is based at least in part on a time domain representation of the modulation applied by the modulation controller.

Aspects can include the following feature.

The modulation controller comprises a phase modulation controller configured to control modulation of a phase of the transmitted optical wave.

In another aspect, in general an apparatus comprises: an optical transmitter configured to provide a beam of a transmitted optical wave scanned over a series of points arranged over a region; an optical receiver configured to receive backscattered portions of the transmitted optical wave and determine measurements associated with the backscattered portions of the transmitted optical wave for each of a plurality of the series of points, wherein the measurements include a measured range and a measured velocity; and a data combination module configured to determine at least one computed range and at least one computed velocity based at least in part on combining (1) first partial data derived from at least one measurement associated with at least one backscattered portion of the transmitted optical wave with (2) second partial data derived from a detector, where the detector comprises at least one of: a camera configured to capture an image including at least a portion of the region; or a radar configured to capture velocity measurements over at least a portion of the region.

Aspects can include one or more of the following features.

The second partial data includes information associated with one or more points in the series of points.

The data combination module is further configured to determine one or more boundary points associated with a boundary of a target within the region and based at least in part on the second partial data.

The apparatus further comprises a frequency modulation controller configured to control modulation of a frequency of the transmitted optical wave, where the modulation of the frequency of the transmitted optical wave includes at least a first slope for each of a plurality of frequency sweeps associated with respective points in the series of points.

The modulation of the frequency of the transmitted optical wave includes a second slope, different from the first slope, for each of a plurality of frequency sweeps associated with one or more boundary points.

The one or more boundary points are associated with a boundary of a target within the region and based at least in part on the second partial data.

In another aspect, in general, a method comprises: providing, by an optical transmitter, a beam of a transmitted optical wave scanned over a series of points arranged over a region; receiving, by an optical receiver, backscattered portions of the transmitted optical wave and determine measurements associated with the backscattered portions of the transmitted optical wave for each of a plurality of the series of points, wherein the measurements include a measured range and a measured velocity; and determining, by a data combination module, at least one computed range and at least one computed velocity based at least in part on combining (1) first partial data derived from at least one measurement associated with at least one backscattered portion of the transmitted optical wave with (2) second partial data derived from a detector, where the detector comprises at least one of: a camera configured to capture an image including at least a portion of the region; or a radar configured to capture velocity measurements over at least a portion of the region.

Aspects can include one or more of the following features.

The second partial data includes information associated with one or more points in the series of points.

The data combination module is further configured to determine one or more boundary points associated with a boundary of a target within the region and based at least in part on the second partial data.

The method further comprises a frequency modulation controller configured to control modulation of a frequency of the transmitted optical wave, where the modulation of the frequency of the transmitted optical wave includes at least a first slope for each of a plurality of frequency sweeps associated with respective points in the series of points.

The modulation of the frequency of the transmitted optical wave includes a second slope, different from the first slope, for each of a plurality of frequency sweeps associated with one or more boundary points.

The one or more boundary points are associated with a boundary of a target within the region and based at least in part on the second partial data.

Aspects can have one or more of the following advantages.

The subject matter disclosed herein can be used to disambiguate the Doppler frequency shift from the range measurement in LiDAR systems. Such Doppler disambiguation can be useful in determining the range and velocity of the target. In some examples, by combining LiDAR detection data collected in one or more previous frames and LiDAR detection data from nearby points, the Doppler frequency shift can be disambiguated from the range measurement without performing multiple frequency chirps at each point. The Doppler frequency shift of a given point may be determined by providing the Doppler frequency shift of nearby points in a spatial scan as input to a digital signal processing module to assist with determining the Doppler frequency shift of the given point. In some examples, a frequency spectrum of a backscattered signal is used as a set of velocity hypotheses for construction of a correctly matched filter, thereby reducing the number of velocity hypotheses evaluated by several orders of magnitude. In such examples, computational complexity may be reduced and the processing times enhanced.

Data from photodetectors (e.g., cameras) and radars may also be fused with the LiDAR data in order to provide additional information for processing and determining the Doppler frequency shift of a set of points. Disambiguating the Doppler frequency shift and the portion of the backscattered light can also be used in binary phase shift keyed (BPSK) protocol so as to enhance the signal-to-noise.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example coherent LiDAR system.

FIG. 2 is a schematic diagram of an example FMCW LiDAR system.

FIG. 3 is a schematic diagram of an example of an optical phased array.

FIG. 4 is a schematic diagram of an example of a grating-antenna-based optical phased array.

FIG. 5 is a schematic diagram of an example of angular steering associated with radiation intensity patterns for optical phased arrays.

FIG. 6 is an example plot of frequency chirping and spatial scanning of a transmitted optical emitted from a FMCW LiDAR system.

FIG. 7 is an example plot of frequency chirping and spatial scanning of a transmitted optical emitted from a FMCW LiDAR system.

FIG. 8 is an example plot of frequency chirping and spatial scanning of a transmitted optical emitted from a FMCW LiDAR system.

FIG. 9 shows an example plot of the phase of a transmitted optical wave emitted from a LiDAR system as a function of time.

FIG. 10 shows an example plot of the phase of a transmitted optical wave emitted from a LiDAR system as a function of time.

FIG. 11 shows a schematic diagram of an example signal processing module.

FIG. 12 shows a schematic diagram of an example signal processing module.

### DETAILED DESCRIPTION

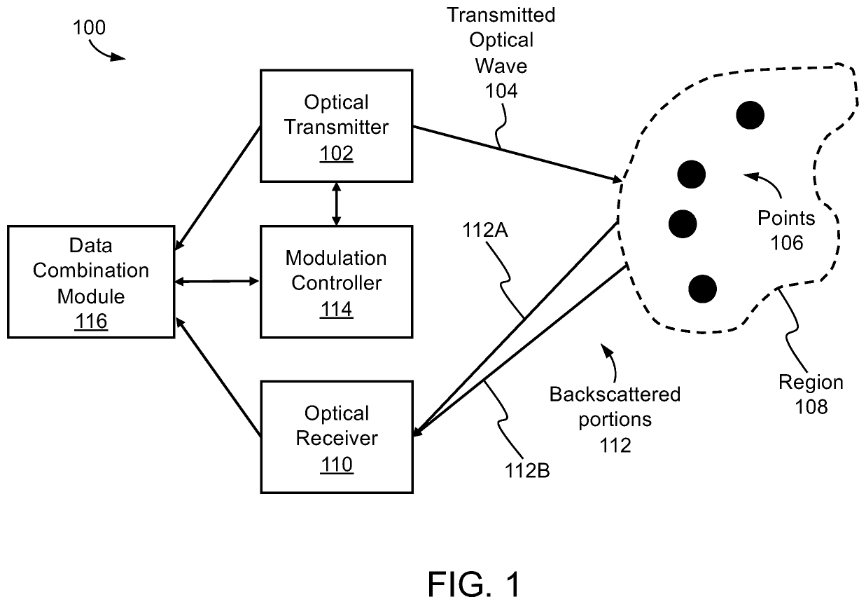

FIG. 1 shows an example coherent LiDAR system 100 comprising an optical transmitter 102 configured to provide a beam of a transmitted optical wave 104 scanned over a series of points 106 arranged over a region 108, where the scanning over the series of points 106 is repeated for each of a plurality of frames. An optical receiver 110 is configured to receive backscattered portions 112A, 112B of the transmitted optical wave 104 and determine measurements associated with the backscattered portions 112A, 112B of the transmitted optical wave 104 for each of a plurality of the series of points 106 for each of a plurality of the plurality of frames. A modulation controller 114 is configured to control modulation of the transmitted optical wave 104. For example, one type of modulation that can be used is frequency modulation in a frequency modulated continuous wave (FMCW) coherent LiDAR system. Alternatively, phase modulation can be used in a binary phase shift keyed (BPSK) coherent LiDAR system. In the case of an FMCW system, the modulation controller 114 controls modulation of a frequency of the transmitted optical wave 104. In some implementations an interleaved chirp pattern can be sued, where the modulation of the frequency of the transmitted optical wave 104 includes, for a first frame of the plurality of frames and a second frame of the plurality of frames: at least a first slope for each of a plurality of frequency sweeps associated with respective points 106 in at least one of the first or second frame, and at least a second slope, different from the first slope, for each of a plurality of frequency sweeps associated with respective points 106 in at least one of the first or second frame, wherein a set of all frequency sweeps for the first frame consists of fewer than two different frequency sweeps for each point in the series of points 106. As described in more detail below, the data combination module 116 is configured (e.g., using digital signal processing circuitry) to determine at least one computed range and at least one computed velocity based at least in part on combining (1) first partial data derived from at least one measurement associated with a first backscattered portion 112A of the transmitted optical wave 104 with (2) second partial data derived from at least one measurement associated with a second backscattered portion 112B of the transmitted optical wave 104. The first backscattered portion 112A of the transmitted optical wave 104 is received by the optical receiver 110 during a frequency sweep at the first slope associated with a first point in the first frame, and the second backscattered portion 112B of the transmitted optical wave 104 is received by the optical receiver 110 during a frequency sweep at the second slope associated with a second point in the first frame different from the first point or associated with at least one point in the second frame.

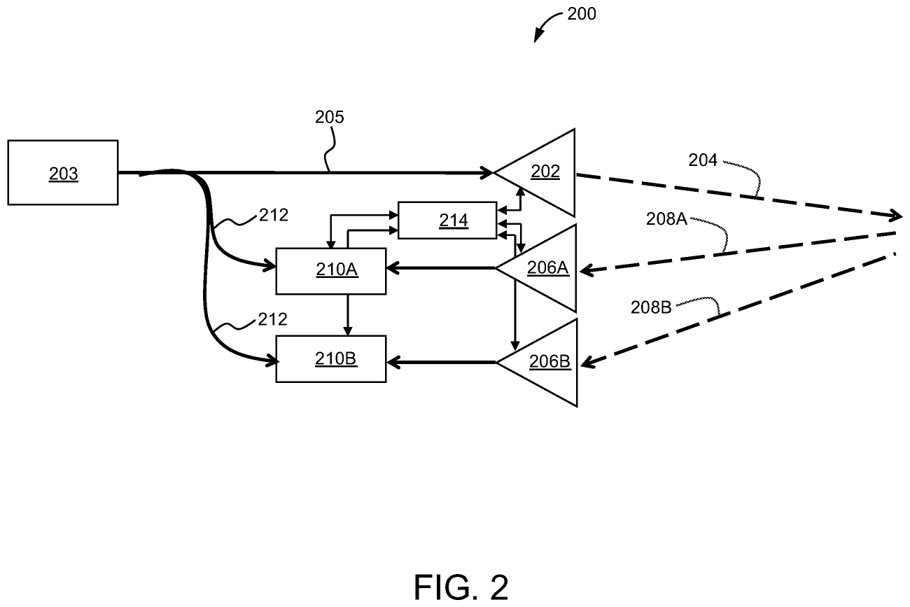

FIG. 2 shows an example of an FMCW LiDAR system 200 that can be implemented as an example of the coherent LiDAR system 100 shown in FIG. 1. The system 200 uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, there is an antenna module configured to operate in both a transmitter (Tx) mode of operation and a receiver (Tx) mode of operation (i.e., in a monostatic arrangement) where the transmitting aperture and the receiving aperture are the same. In the example of FIG. 2, the system 200 includes a transmitter antenna module 202 that transmits an optical beam 204 at an angle that can be steered over a steering range, and two receiver antenna modules 206A and 206B that can each be controlled to receive light incoming from a particular angle (i.e., a multi-static arrangement). For example, the receiver antenna module 206A can be configured to receiving incoming light 208A including a portion of the optical beam 204 backscattered from a target object or region, and the receiver antenna module 206B can be configured to receive incoming light 208B including a portion of the optical beam 204 backscattered from the target.

The system includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. Coherent receiver modules 210A and 210B receiving collected light from receiver antenna modules 206A and 206B, respectively, are configured to coherently mix the collected light with light of a local oscillator (LO) 212, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

A control module 214 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

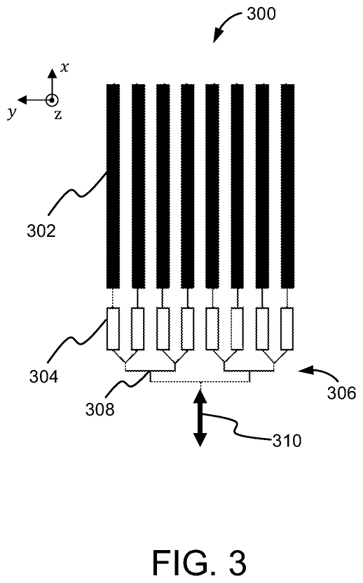

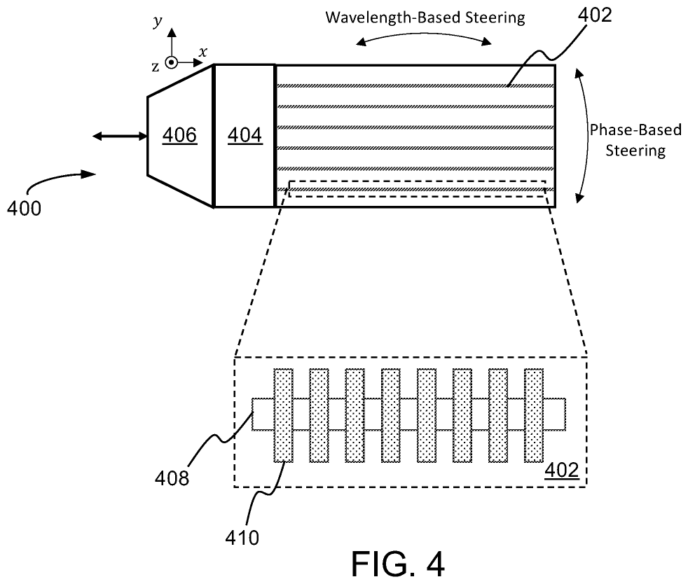

Any of a variety of techniques can be used to steer the transmission angle of the optical beam 204 provided by the transmitter antenna module 202 over a steering range, and to steer the reception angle of the receiver antenna modules 206A and 206B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 3 shows an example OPA 300 that includes an array of optical antennas 302. Light can be emitted from (and/or received into) optical antennas 302 from different emission planes depending on the type of optical antennas being used. For a grating-antenna-based OPA, each optical antenna is configured as an optical grating, as described in more detail in FIG. 4, and power from individual optical waves is emitted gradually over the length of the optical gratings over an emission plane in the plane of the page in FIG. 3 (the x-y plane). Alternatively, for an end-fire-antenna-based OPA, each optical antenna is configured to emit light from the ends of the optical antennas at an emission plane that is perpendicular to the plane of the page in FIG. 3 (the y-z plane). In either case, the optical waves optically interfere with each other starting at the emission plane to form an optical phased array output beam when the OPA 300 is used as a transmitter. The direction of peak constructive interference depends on the relative phase shifts imposed on light entering the optical antennas.

The OPA 300 includes an array of optical phase shifters 304 that impose respective phase shifts on optical waves provided as phase shifted optical waves entering the respective optical antennas 302 when the OPA is used as a transmitter, or on optical waves that have been collected by respective optical antennas 302 when the OPA is used as a receiver. The optical phase shifters 304 can be, for example, electro-optic, thermal, liquid crystal, pn junction phase shifters. In some examples, each of the optical phase shifters 304 is controlled independently, while in other examples two or more of the optical phase shifters 304 may be jointly controlled. An optical coupler 306 is configured to couple an optical port 310 to the array of optical phase shifters 304. In this example, the optical coupler 306 is in the form of a power splitting network formed form interconnected power splitters 308. In this example, the power splitters 308 are 1×2 power splitters (also referred to as 50/50 power splitters) and are interconnected by waveguides in a binary tree arrangement to achieve substantially equal power into each optical phase shifter 304 from an input optical wave entering the optical port 310 when the OPA 300 is used as a transmitter (Tx operation), and to provide substantially equal path lengths between each optical phase shifter 304 and the optical port 310. When the OPA 300 is used as a receiver (Rx operation), the light received by the optical antennas 302 and phase shifted by the optical phase shifters 304 is combined into an output optical wave at the optical port 108, which can then be further manipulated, transformed, or measured.

FIG. 4 shows an example of a grating-antenna-based OPA 400 that is configured for phase-based steering about the x axis and wavelength-based steering about they axis. For example, when configured for Tx operation, optical waves propagate along optical grating antennas 402 (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a phase shifter (PS) module 404 and the steering in the other angular direction being performed by wavelength of an optical wave distributing optical power via an optical coupler 406. The adjustment of the transmission angle for the Tx operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch p1 (e.g., a constant spacing between grating elements 410) to perturb the guided optical wave causing emission in the direction of the grating elements 410. The angle at which the light is emitted from each optical grating antenna 402 depends on a relationship between the pitch p1 and the wavelength, and thus can be steered by changing the wavelength.

The PS module 404 can also be configured to provide focusing. For example, the emitted light can have a nonlinear phase front imposed on it by the phase shifters in the PS module 404 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

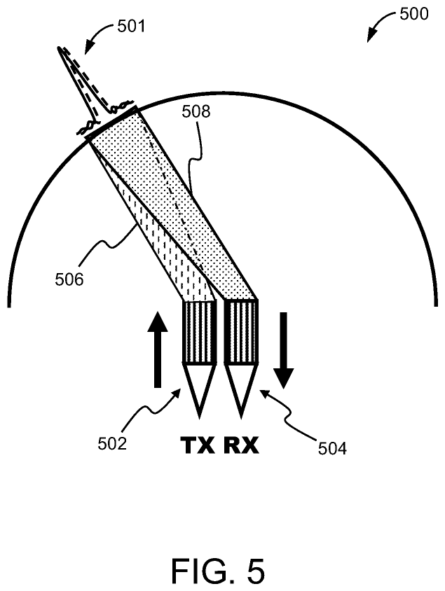

FIG. 5 shows an example LiDAR system 500 producing radiation intensity patterns 501 associated with a transmitter OPA 502 and a receiver OPA 504. In this example, main lobes associated with a transmitter radiation pattern 506 and a receiver radiation pattern 508 overlap. Such an arrangement of main lobe overlap can result, for example, from tuning phase shifters associated with transmitter and receiver optical antennas in the respective OPAs. Backscattered light from a target object (or simply “object”) situated near the main lobes is received by the receiver OPA 504. In each radiation intensity pattern, there may be a main lobe and additional grating lobes that occur on each side of the main lobe due to the limit in how close adjacent optical antennas can be in an OPA, which may limit the phase-based angular tuning range. In some implementations, the examples described herein may be designed to operate over a predetermined range of optical wavelengths such as, for example, the λ=1500 to 1600 nm band or the λ=1270 to 1330 nm band, and the pitch p2 corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm≤p2≤4000 nm may be typical.

In general, LiDAR systems may measure the time delay between the transmission of an optical wave and the reception of light backscattered from a target. Depending on the type of LiDAR system used, time delay information may be determined in a variety of ways (e.g., by using a frequency chirp or an encoded modulation, as described in more detail below), and in some cases may be determined by combining partial information obtained from different measurements. A LiDAR system is able to use this time delay information and other information to determine the azimuth, elevation, and range of a large set of points (i.e., a point cloud) around the target at a repeated rate (i.e., the frame rate). The azimuth and elevation relative to the frame of reference located at an aperture of the LiDAR system can be determined based on beam steering information corresponding to scanning an emitted beam of light to each of the points during a given frame. In some examples, the output of the LiDAR system can be likened to a three-dimensional video. Coherent LiDAR systems are additionally able to measure the downrange velocity of the target, thereby generating a four-dimensional point cloud comprising information associated with the azimuth, elevation, range, and velocity of the target.

Coherent LiDAR systems can perform measurements by interfering the backscattered light with a local oscillator (LO). In some examples, a laser source outputs light that is divided into two paths, where one path is transmitted to the target and another path is used as a LO. When the backscattered light and the LO are combined in a photodiode-based detector, the optical interference and limited bandwidth of the photodiode-based detector results in a nonlinear mixing process that down-converts a frequency associated with the optical interference from optical frequencies to electrical frequencies, allowing the coherent LiDAR system to measure a signal proportional to the electric field of the light. In general, measuring the electric field of the light can provide several advantages. For example, electric field measurement can increase the sensitivity of the optical receiver through the nonlinear mixing process, can limit the dynamic range of the received signal and therefore simplify the measurement electronics utilized, and can enable measurement of down-range target velocity with high accuracy due to the Doppler effect. Furthermore, instead of measuring intensity, which is proportional to the square of the amplitude of the electric field, measuring electric field can reduce interference from unwanted light sources (e.g., sunlight or crosstalk from nearby LiDAR systems) by filtering out light at frequencies that substantially differ from the frequency of the LO.

Coherent LiDAR systems can also present additional challenges, such as differentiating between a frequency shift due to the Doppler effect associated with the target velocity and a frequency shift due to the time delay corresponding to range (i.e., the distance between the LiDAR system and the target). In a frequency modulated continuous wave (FMCW) LiDAR system, the respective frequencies of a first optical wave transmitted to a target and a second optical wave associated with the LO are swept (i.e., modified). Performing a frequency sweep is also referred to as a frequency chirp. In some examples, the frequency chirp applied to the first and second optical waves is linear in time so that the nonlinear mixing of the two optical waves produces, in the case of a static target, a pure sine wave tone characterized by an oscillation frequency that is proportional to the range. However, in the case of a moving target, the Doppler effect also causes a shift in the oscillation frequency, which can be confused with frequency shift due to time-of-flight that is associated with range. Thus, some FMCW LiDAR systems may perform a first and a second linear frequency sweep (i.e., two frequency chirps) in rapid succession. The first linear frequency sweep is characterized by a positive rate of change of frequency as a function of time (i.e., an up-sweep chirp) and the second linear frequency sweep is characterized by a negative rate of change of frequency as a function of time (i.e., a down-sweep chirp). In such examples, a first optical wave that is emitted at a first frequency during the up-sweep chirp is backscattered from the target and returns to the FMCW LiDAR system to be interfered with a second optical wave associated with the LO. Due to the time-of-flight (i.e., time delay) that the first optical wave underwent, the second optical wave that it is interfering with was emitted after the first optical wave, and therefore was emitted at a second frequency during the up-sweep chirp that is larger than the first frequency. Thus, the time delay associated with range (i.e., due to time-of-flight) results in a negative frequency shift for the up-sweep chirp and a positive frequency shift for the down-sweep chirp, whereas the target velocity results in the same frequency shift for both the up-sweep and down-sweep chirps (i.e., the Doppler frequency shift is common mode to the up-sweep and down-sweep chirps). Therefore, the Doppler frequency shift is proportional to the sum of the frequency detected in the up-sweep and down-sweep chirps, while the frequency shift due to the range is proportional to the difference of the frequency detected in the two chirps. While this approach allows for the discrimination of time-delay and Doppler frequency shift, it comprises two detection decisions that can be associated with a link budget penalty on the order of 3 dB, for example, since the measurement for each detection decision results in about twice the amount of time, or if the total time is fixed, each measurement in half the amount of time but is based on an amount of light collected that is half as much as the amount of light collected for a single detection decision.

Doppler-based systems can also be realized in other types of coherent LiDAR systems that do not utilize FMCW. Such systems may, for example, generate a range-Doppler map, where the processor of the LiDAR system constructs many hypotheses about the range and the velocity of the target. To form a detection decision, for each hypothesis the processor calculates the strength of the overlap of a hypothesized received signal with the actual received signal. Whereas this approach avoids emitting two waveforms (i.e., the up-sweep and down-sweep chirps), and thus avoids the aforementioned link budget penalty, the processing complexity of the LiDAR system may be increased.

Another example of a coherent LiDAR system is a binary phase shift keyed (BPSK) LiDAR system, which can, for example, emit an optical signal with a duration of 10 microseconds and comprising 10,000 pseudo-random phase codes at a 1 nanosecond chip rate. For example, if the maximum time-of-flight is 1 microsecond and the Doppler frequency shift is between ±100 MHz, then the processor of the LiDAR system may evaluate on the order of one million range-Doppler hypotheses since there are 1000 range hypotheses and 1000 Doppler hypotheses. The large number of evaluations can increase the computational complexity by a factor of 1000 in comparison to a system where the velocity of the target is known.

The subject matter disclosed herein can be used to disambiguate the Doppler frequency shift from the range measurement in a LiDAR system. In each approach there can be various trade-offs between signal processing complexity and measurement time (i.e., LiDAR performance).

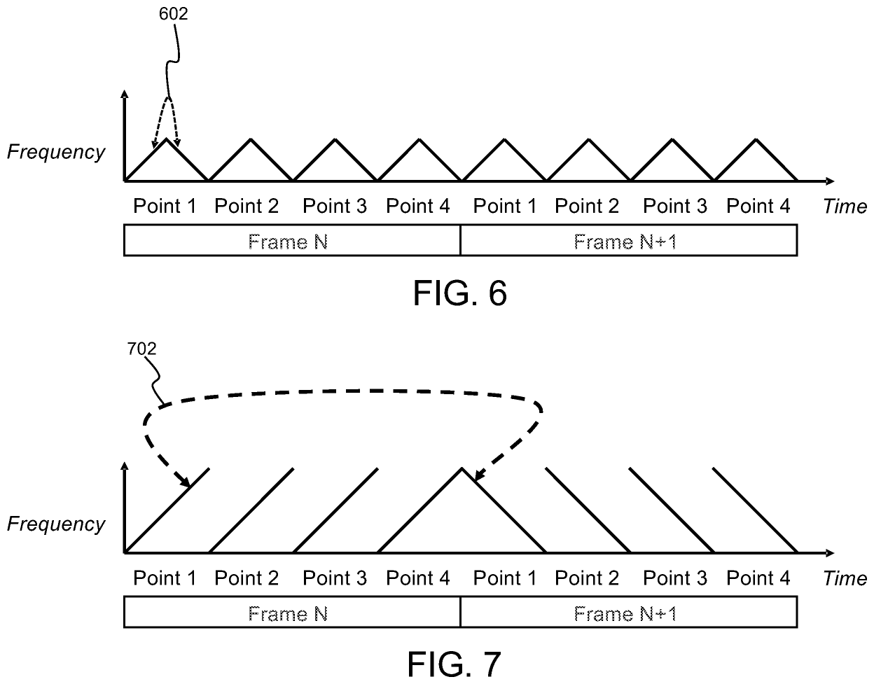

FIG. 6 shows an example plot of frequency chirping and spatial scanning of a transmitted optical wave emitted from a FMCW LiDAR system. Within each frame (e.g., Frame N or Frame N+1), the spatial scanning scans over a set of points sequentially in a predetermined order (e.g., scanning back and forth horizontally while scanning vertically) and, while dwelling at a fixed location in the spatial scan over a period of time for processing a point, the frequency of the transmitted optical wave increases and decreases for that point (i.e., an up-sweep and a down-sweep chirp is performed at every point in a frame). The time needed to scan from one point to the next is substantially smaller than the dwell time, so that time is not depicted in this and other plots of modulation over time for the series of points. Doppler disambiguation for a particular point is performed using only data 602 detected from that point in a single frame.

In some examples, LiDAR systems can generate a large volume of detection data that can be used instead of performing both an up-sweep and a down-sweep chirp at every point in the scene (i.e., the point cloud) for a given frame. For example, by combining LiDAR detection data collected in one or more previous frames and LiDAR detection data from nearby points, the Doppler frequency shift can be disambiguated from the range measurement without performing multiple frequency chirps at each point. Such techniques may utilize an assumption of continuity across time to perform frame-to-frame Doppler disambiguation and an assumption of continuity across space to perform Doppler disambiguation using nearby points.

FIG. 7 shows an example plot of frequency chirping and spatial scanning of a transmitted optical wave emitted from a FMCW LiDAR system that interleaves up-sweep and down-sweep chirps across frames to disambiguate the Doppler frequency shift. Within each frame, the spatial scanning scans over a set of points and the frequency of the transmitted optical wave either increases or decreases for each point (i.e., either an up-sweep or a down-sweep chirp is performed at every point in a frame). In this example, the FMCW LiDAR system alternates on a frame-by-frame basis between performing up-sweep chirps for every point and down-sweep chirps for every point. Points that correspond to the same object are paired between adjacent frames and the Doppler frequency shift is disambiguated on a frame-to-frame basis for these points. Doppler disambiguation for a particular point is performed using data 702 detected from that point across two or more frames.

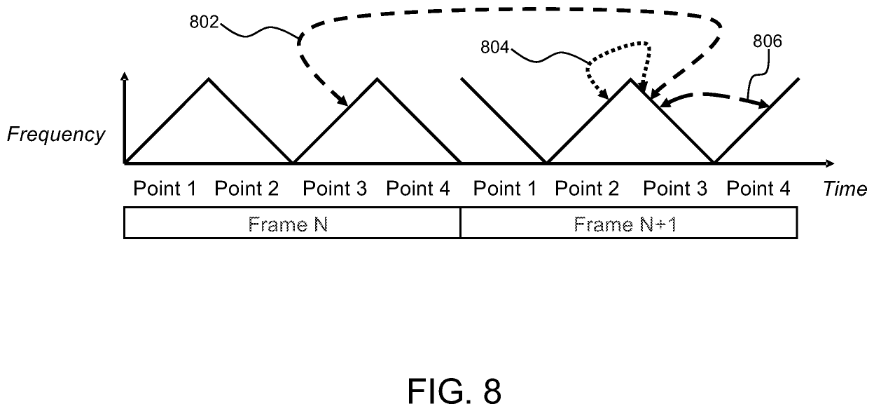

FIG. 8 shows an example plot of frequency chirping and spatial scanning of a transmitted optical wave emitted from a FMCW LiDAR system that uses data from adjacent frames and from adjacent points (e.g., in the vertical and/or horizontal direction) to disambiguate the Doppler frequency shift. Within each frame (e.g., Frame N or Frame N+1), the spatial scanning scans over a set of points and the frequency of the transmitted optical wave either increases or decreases for each point (i.e., either an up-sweep or a down-sweep chirp is performed at every point in a frame). In this example, the slope of the frequency chirping for each point varies point-to-point and may also vary frame-to-frame. Points that correspond to the same object are paired between adjacent frames. Doppler disambiguation for a particular point (e.g., Point 3) is performed using a first set of data 802 detected from that point across two or more frames, a second set of data 804 associated with a first nearby point (e.g., Point 2), and a third set of data 806 associated with a second nearby point (e.g., Point 4). In this example, the frequency chirping alternates between up-sweep and down-sweep chirps. In other examples, the frequency chirping can be changed by other means to differentiate between range and the Doppler frequency shift. For example, alternately doubling and halving the slope of the frequency chirping between adjacent points or adjacent frames, or alternately setting the slope of the frequency chirping to be zero and nonzero between adjacent points or adjacent frames. In some cases, the points that correspond to the same object, or same portion of an object, are assumed to be at the same angular location in the spatial scanning. Or, in other cases, those points may be assumed to be at a different angular location (e.g., if the object is assumed or measured to be moving transverse to the line of sight of the FMCW LiDAR system). If object tracking assumptions are incorrect, there can be errors in the estimated values that can be reduced or eliminated over time. In general, object tracking can be determined using any of a variety of techniques, including techniques applying machine learning algorithms.

For example, consider the processing of received backscattered portions of a transmitted optical wave that are scattered from a planar target (e.g., a flat surface in a plane perpendicular to the line of sight) moving towards a FMCW LiDAR system. In this example, point n from frame m is imaging the same location on the planar target as point n in frame m+1. At first glance, it may appear that there are only two measurements and four unknowns. However, the dimensionality of the problem can be reduced by modeling target dynamics and/or through bootstrapping. In modelling target dynamics, for example, an assumption can be made about the motion profile of the target constant velocity or constant acceleration. In the example of constant velocity, the Doppler shift in frame m can be assumed to be the same as the Doppler shift in frame m+1. By combining this assumption with an up-sweep chirp in frame m and an equal and opposite slope down-sweep chirp in frame m+1, the Doppler frequency shift may be calculated as

$${f}_{Doppler} = \frac{{f}_{m} + {f}_{m + 1}}{2 + ζ} ,$$

where ζ is a correction factor related to the slope of the chirp and the time delay between frame m and m+1 that accounts for the range walk that occurred between these two frames. With the Doppler frequency shift identified, the frequency shift due to range may then be calculated as f_{range}(m+1)=fₘ₊₁−r_{Doppler}. In the bootstrapping approach, the a priori known range and velocity in frame m is used to seed the solution discovered for frame m+1. As an example, if the constant velocity assumption is maintained, and the range and Doppler frequency shift in frame m are known, the problem is over-constrained since the Doppler frequency shift in frame m+1 is assumed to be the same as it is in frame m, and the range in frame m+1 can be calculated from the range and velocity in frame m. The allocation of detected frequency (i.e., to the Doppler frequency shift and to the range) that minimizes the least-squares difference between the bootstrapped estimate of range and velocity from the prior frame and the frequency detected in frame m+1 may then be selected.

Instead of compensating the Doppler frequency shift by assuming smoothness in time, the Doppler frequency shift may instead be compensated by assuming smoothness in space. In the same example of the planar target, the processor of the LiDAR may estimate the range and velocity of point n based on the frequency detected at nearby points, such as points n+1, n−1, as well as points in the scan line above or below point n. One approach to this is to compensate the Doppler frequency shift based on the closest prior point. Another is to aggregate the compensation of the Doppler frequency shift based on a set of adjacent points. Disagreements between the compensation of the Doppler frequency shift achieved with nearby points can be solved by discarding outliers, averaging results, or flagging the result as unreliable, for example. In this approach, corners or other discontinuities of objects, which can cause non-physical reports of velocity and/or range, can be flagged by looking for discontinuities in the reported range or velocity.

In the case described above and in other examples, there may be corner cases that can be handled by the FMCW LiDAR system. For example, if the target is moving cross-range with respect to the FMCW LiDAR system (i.e., perpendicular to the line of sight), then there is a subset of points that were imaging the background in frame m and the target in frame m+1. Thus, assumptions of temporal continuity are not valid in this case because point n is addressing two different objects in frame m and frame m+1. The FMCW LiDAR system may be configured to identify where such corner cases have occurred so that it may flag the data as invalid, change the model assumptions to correct the estimate, or take additional measurements to correct the estimate, for example. There are several cues that may be used to identify that the Doppler disambiguation has failed, such as a non-physical range-to-target (e.g., a negative range), a non-physical velocity (e.g., an extremely large velocity), or chaotic movement (e.g., an extremely large acceleration). Once the point-cloud is formed, segmentation of the cloud can provide useful insight regarding where the corner cases will appear. For example, any boundaries in the cross-range direction that show a discontinuity in range or velocity are likely to fail the assumption of temporal or spatial continuity.

More generally, a scene that is imaged by a coherent LiDAR system (e.g., a FMCW LiDAR system) may have the point cloud segmented in time and space based on the intensity of the returns (i.e., the received backscattered portions of a transmitted optical wave), the spatial location of the returns, the velocity of the returns, the proximity in time of the points, the proximity within the field of view of the LiDAR system, or a combination of these elements. The output of the point cloud segmentation may be a group of associated points for which it is more likely than not that there is a degree of spatial or temporal continuity in the velocity and position of the points that sample the object. In such examples, a FMCW LiDAR system may perform a mixture of frequency chirps of varying slope (e.g., up-sweep and down-sweep chirps) such that the collection of points may be processed in bulk to determine the range and velocity at every point that maximizes or otherwise optimizes smoothness of the range and/or velocity map.

For FMCW LiDAR systems with adjustable spatial scanners (e.g., optical phased arrays), it is possible to revisit points that are identified as having unreliable Doppler disambiguation results. The FMCW LiDAR system may go through a process where it scans a set of points, identifies a subset of those points that need additional measurement, and then uses additional time to direct the beam (i.e., the transmitted optical wave) back to the identified problematic point to perform additional measurements to disambiguate the Doppler frequency shift. For these cases, it may be useful to perform both an up-sweep and a down-sweep chirp at each point in order to simplify the Doppler disambiguation problem. This approach potentially suffers from non-deterministic frame timing, which could be overcome by allotting a time period for a pre-determined number of flagged points in each frame, ranking problematic points from most problematic to least problematic, and revisiting only the most troublesome points, for example.

Data from photodetectors (e.g., cameras) and radars may also be fused with the LiDAR data in order to seed the Doppler shift compensation algorithm. Radars can provide direct measurement of velocity, though may have a lower angular resolution than LiDAR systems. Velocity data that is available from the radar may be used to seed the Doppler shift compensation algorithm in the LiDAR system. Photodetectors, such as cameras, can provide shape information with high angular resolution. Shape boundaries identified in the camera are likely to be range or Doppler boundaries in the LiDAR system and can be used to flag locations within the field of view of the LiDAR system where Doppler disambiguation may warrant additional or different processing techniques. For example, such information may be used to schedule an up-sweep and a down-sweep chirp at each flagged point instead of just one sweep.

In the example of a FMCW LiDAR system that performs an up-sweep and a down-sweep chirp at every point (e.g., as shown in FIG. 6), the FMCW LiDAR may benefit from skipping the down-sweep chirp if no target was detected in the up-sweep portion of the chirp. There may not be a penalty for such skipping, since a detection is performed in both the up-sweep and the down-sweep to report a valid target. However, if steering and chirping are performed, this implies a possibly challenging latency requirement (i.e., near zero-latency) in the detection decision and the spatial scanning, which may be difficult to implement. This latency requirement can be mitigated by re-timing the spatial scanning and chirp timing (e.g., as shown in FIG. 7) such that a number of up-sweep chirps are performed at different points, then the spatial scanner revisits those same points to perform the down-sweep chirps. In some examples, if there was no detection in the up-sweep for point n, then the down-sweep for point n is skipped, thereby saving time and light.

For non-FMCW coherent LiDAR, Doppler frequency shifts also affect the received light and may be designed to ensure a high signal-to-noise ratio in the received data. By carefully choosing the waveform, the processing load can be reduced, possibly at the cost of spending additional time per point.

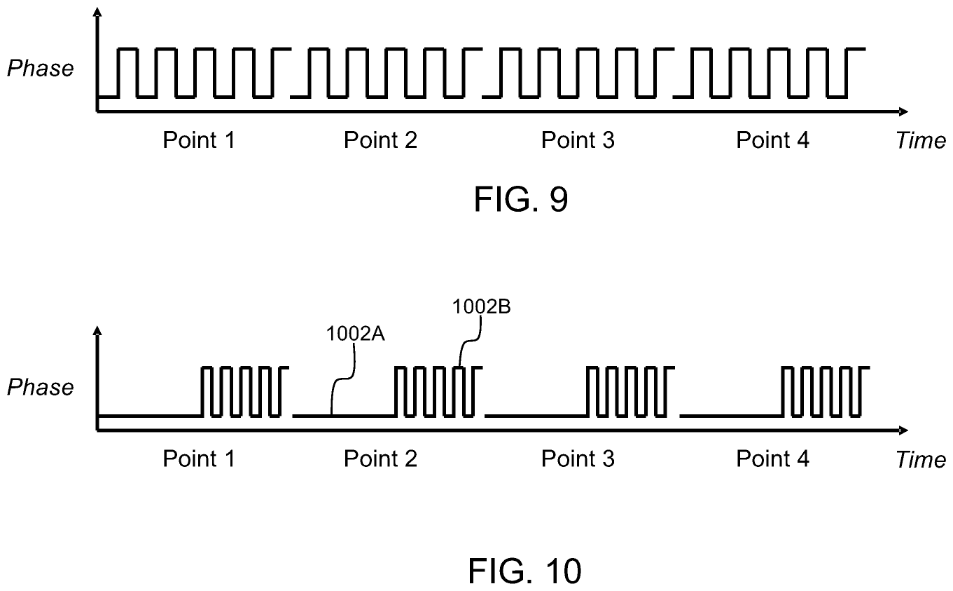

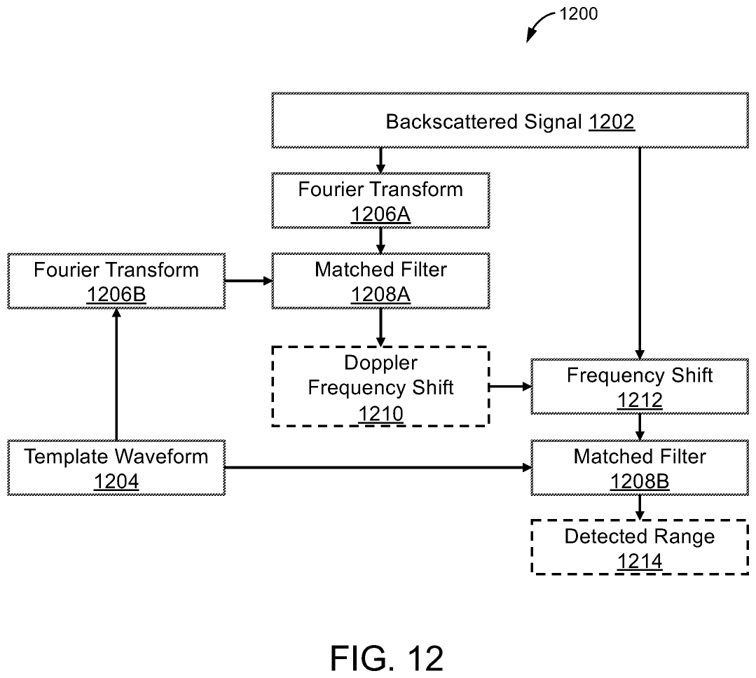

FIG. 9 shows an example plot of the phase of a transmitted optical wave emitted from a LiDAR system as a function of time. In this example, the transmitted optical wave is encoded with a non-augmented BPSK waveform that is associated with an optical wave having a constant amplitude and frequency and a phase that is modulated according to a pseudo-random bit sequence emitted at each point in the spatial scanning. In some implementations, a different pseudo-random bit sequence can be used for each point to ensure that light collected while dwelling on a given point was not delayed by a long enough light propagation time such that it was received from light transmitted while processing a previous point. While the simple example illustrated in FIG. 9 shows the modulated phase changing between the two values of the binary modulation at each time interval (i.e., according to a simple alternating bit sequence of 0, 1, 0, 1, 0, 1, . . . ), a typical pseudo-random bit sequence would show the modulated phase changing between the two values of the binary modulation according to a more random appearing bit sequence (e.g., 0, 1, 1, 0, 1, 0, 0, 0, 1, 0, 1, 1, . . . ). This simplification is made for illustration purposes, and not to suggest that the bit sequence used is not pseudo-random. This simplification for illustration purposes also appears in the pseudo-random modulation used in FIG. 10. A technique used to determine the Doppler frequency shift and the range of a target at each point (e.g., as described with reference to FIG. 12 below) may use multiple matched filters applied within different respective portions of the processing time for a given point. An alternative technique that uses a single matched filter can be implemented using an augmented BPSK waveform.

FIG. 10 shows an example plot of the phase of a transmitted optical wave emitted from a LiDAR system as a function of time. In this example, the transmitted optical wave is encoded with an augmented BPSK waveform comprising a first portion 1002A in which there is a constant phase on the transmitted optical wave for determining the Doppler frequency shift and a second portion 1002B associated with an optical wave that is modulated according to a pseudo-random bit sequence for determining the range. By allocating a fraction of the BPSK waveform to a constant-phase waveform portion (i.e., the first portion 1002A), detection processing may be performed independently on the first portion 1002A of the waveform to extract the Doppler frequency shift, or in some cases multiple hypotheses for the Doppler frequency shift, of the target. Encoding the transmitted optical wave with an augmented BPSK waveform can limit the set of Doppler hypotheses evaluated during a signal processing module implemented on digital signal processing (DSP) circuitry (e.g., an application-specific integrated circuit, or a computing device with one or more processor cores).

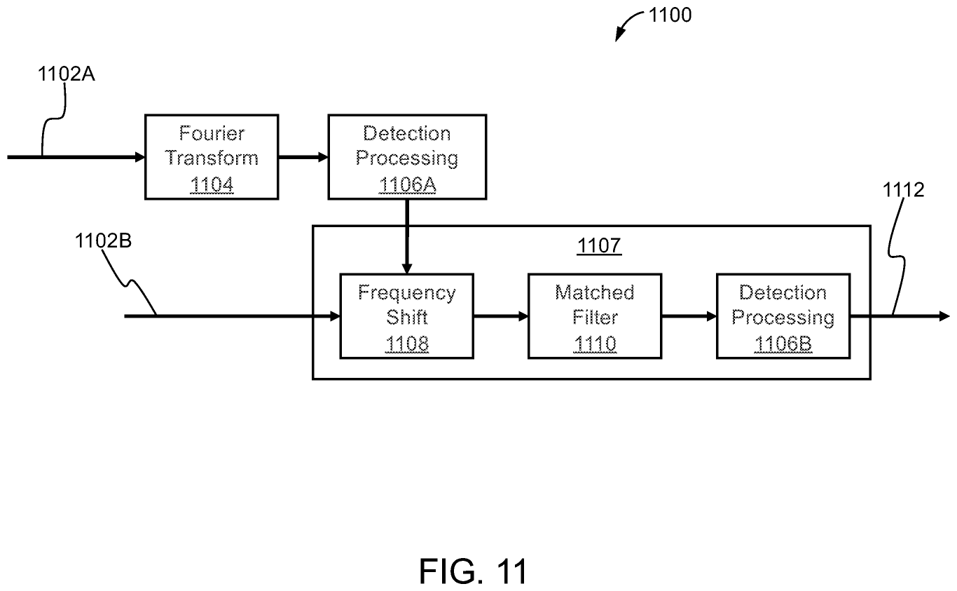

FIG. 11 shows an example signal processing module 1100 that receives a first backscattered signal 1102A associated with a first backscattered portion of a transmitted optical wave during a constant-phase portion (e.g., the first portion 1002A of FIG. 10) of an augmented BPSK waveform. A frequency spectrum signal of the first backscattered signal 1102A is generated by performing a Fourier Transform 1104, thus providing a direct measurement of all of the Doppler frequency shifts present in the first backscattered signal 1102A. The frequency spectrum signal is then processed by a first round of detection processing 1106A, where the frequency spectrum signal is used as a set of velocity hypotheses for construction of a range detection unit 1107, thereby reducing the number of velocity hypotheses evaluated by several orders of magnitude. For each Doppler frequency shift detected by the first round of detection processing 1106A, the range detection unit 1107 determines possible ranges associated with the Doppler frequency shift. Within the range detection unit 1107, a second backscattered signal 1102B associated with a second backscattered portion of a transmitted optical wave during a pseudo-random bit sequence phase-modulated portion (e.g., the second portion 1002B of FIG. 10) of an augmented BPSK waveform undergoes a frequency shift 1108 based at least in part on the Doppler frequency shift currently being processed by the range detection unit 1107. The frequency shifted signal is then sent to a matched filter 1110 and undergoes a second round of detection processing 1106B that outputs the detected ranges 1112. In this example, the frequency shift 1108 and the matched filter 1110 are separate units, but in other cases the frequency shift 1108 can be directly incorporated in the matched filter 1110 for each Doppler frequency shift detected.

FIG. 12 shows an example signal processing module 1200 that receives a backscattered signal 1202 associated with a backscattered portion of a transmitted optical wave encoded with a non-augmented BPSK waveform. A template waveform 1204 is based at least in part on the non-augmented BPSK waveform. Compared to the case of an augmented BPSK waveform, a possibly small amount of additional complexity can be added to the signal processing so as to extract the Doppler frequency shift from the backscattered signal 1202 of the non-augmented BPSK waveform with a phase modulated according to a pseudo-random bit sequence (e.g., as in the example of FIG. 9). A first Fourier transform 1206A of the backscattered signal 1202 can be performed, the results of which can be sent to a first matched filter 1208A that is applied in the frequency domain. The first matched filter 1208A can be generated based at least in part on a second Fourier transform 1206B of the template waveform 1204. The output of the first matched filter 1208A can be used to estimate the Doppler frequency shift 1210 of the backscattered signal 1202. The Doppler frequency shift 1210 can then be accounted for by performing a frequency shift 1212 of the backscattered signal 1202. The frequency shifted signal can then be sent to a second matched filter 1208B that is applied in the time domain and is based at least in part on the template waveform 1204, thereby resulting in a detected range 1214. The signal processing module 1200 may allow for a link budget improvement (e.g., of 3 dB) of a LiDAR system utilizing a non-augmented BPSK waveform instead of an augmented BPSK waveform.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an optical transmitter configured to provide a beam of a transmitted optical wave scanned over a series of points arranged over a region, where the scanning over the series of points is repeated for each of a plurality of frames;
an optical receiver configured to receive backscattered portions of the transmitted optical wave and determine measurements associated with the backscattered portions of the transmitted optical wave for each of a plurality of the series of points for each of a plurality of the plurality of frames; and
a frequency modulation controller configured to control modulation of a frequency of the transmitted optical wave, where the modulation of the frequency of the transmitted optical wave includes, for a first frame of the plurality of frames and a second frame of the plurality of frames:
at least a first slope for each of a plurality of frequency sweeps associated with respective points in at least one of the first or second frame, and
at least a second slope, different from the first slope, for each of a plurality of frequency sweeps associated with respective points in at least one of the first or second frame,
wherein a set of all frequency sweeps for the first frame consists of fewer than two different frequency sweeps for each point in the series of points; and
a data combination module configured to determine at least one computed range and at least one computed velocity based at least in part on combining (1) first partial data derived from at least one measurement associated with a first backscattered portion of the transmitted optical wave with (2) second partial data derived from at least one measurement associated with a second backscattered portion of the transmitted optical wave, where:
the first backscattered portion of the transmitted optical wave is received by the optical receiver during a frequency sweep at the first slope associated with a first point in the first frame, and
the second backscattered portion of the transmitted optical wave is received by the optical receiver during a frequency sweep at the second slope associated with a second point in the first frame different from the first point or associated with at least one point in the second frame.

2. The apparatus of claim 1, wherein the set of all frequency sweeps for the first frame consist of frequency sweeps having the first slope, and a set of all frequency sweeps for the second frame consist of frequency sweeps having the second slope.

3. The apparatus of claim 1, wherein a frequency sweep for each point in the first frame has a slope that is different from a slope of a frequency sweep for that point in the second frame.

4. The apparatus of claim 1, wherein at least one point in the second frame is skipped based at least in part on a measurement associated with that point in the first frame.

5. The apparatus of claim 1, wherein the set of all frequency sweeps for the first frame are not identical to a set of all frequency sweeps for the second frame.

6. The apparatus of claim 1, wherein the second slope has an identical magnitude and opposite sign from the first slope.

7. The apparatus of claim 1, wherein both the first slope and the second slope are nonzero.

8. The apparatus of claim 1, wherein the data combination module is further configured to determine the at least one computed range and the at least one computed velocity based at least in part on a third backscattered portion of the transmitted optical wave received by the optical receiver during a frequency sweep at a third slope associated with at least one point in a third frame.

9. A method comprising:
providing, by an optical transmitter, a beam of a transmitted optical wave scanned over a series of points arranged over a region, where the scanning over the series of points is repeated for each of a plurality of frames;
receiving, by an optical receiver, backscattered portions of the transmitted optical wave and determine measurements associated with the backscattered portions of the transmitted optical wave for each of a plurality of the series of points for each of a plurality of the plurality of frames; and
controlling, by a frequency modulation controller, modulation of a frequency of the transmitted optical wave, where the modulation of the frequency of the transmitted optical wave includes, for a first frame of the plurality of frames and a second frame of the plurality of frames:
at least a first slope for each of a plurality of frequency sweeps associated with respective points in at least one of the first or second frame, and
at least a second slope, different from the first slope, for each of a plurality of frequency sweeps associated with respective points in at least one of the first or second frame,
wherein a set of all frequency sweeps for the first frame consists of fewer than two different frequency sweeps for each point in the series of points; and
determining, by a data combination module, at least one computed range and at least one computed velocity based at least in part on combining (1) first partial data derived from at least one measurement associated with a first backscattered portion of the transmitted optical wave with (2) second partial data derived from at least one measurement associated with a second backscattered portion of the transmitted optical wave, where:
the first backscattered portion of the transmitted optical wave is received by the optical receiver during a frequency sweep at the first slope associated with a first point in the first frame, and
the second backscattered portion of the transmitted optical wave is received by the optical receiver during a frequency sweep at the second slope associated with a second point in the first frame different from the first point or associated with at least one point in the second frame.

10. The method of claim 9, wherein the set of all frequency sweeps for the first frame consist of frequency sweeps having the first slope, and a set of all frequency sweeps for the second frame consist of frequency sweeps having the second slope.

11. The method of claim 9, wherein a frequency sweep for each point in the first frame has a slope that is different from a slope of a frequency sweep for that point in the second frame.

12. The method of claim 9, wherein at least one point in the second frame is skipped based at least in part on a measurement associated with that point in the first frame.

13. The method of claim 9, wherein the set of all frequency sweeps for the first frame are not identical to a set of all frequency sweeps for the second frame.

14. The method of claim 9, wherein the second slope has an identical magnitude and opposite sign from the first slope.

15. The method of claim 9, wherein both the first slope and the second slope are nonzero.

16. The method of claim 9, further comprising determining the at least one computed range and the at least one computed velocity based at least in part on a third backscattered portion of the transmitted optical wave received by the optical receiver during a frequency sweep at a third slope associated with at least one point in a third frame.

17. An apparatus comprising:
an optical transmitter configured to provide a beam of a transmitted optical wave scanned over a series of points arranged over a region;
an optical receiver configured to receive backscattered portions of the transmitted optical wave and determine measurements associated with the backscattered portions of the transmitted optical wave for each of a plurality of the series of points, wherein the measurements include measurements used to determine at least one computed range and at least one computed velocity; and
a phase modulation controller configured to control modulation of a phase of the transmitted optical wave, where the modulation of the phase of the transmitted optical wave includes, for each of a plurality of the points in the series of points:
a first time period in which there is a constant phase, and
a second time period in which there is a non-constant phase modulated between at least two different phases.

18. The apparatus of claim 17, wherein, for each of the plurality of the points in the series of points, an amplitude of the transmitted optical wave is constant during the second time period in which there is a non-constant phase modulated between at least two different phases.

19. The apparatus of claim 18, wherein an amplitude of the transmitted optical wave is constant over an entire time period over all of the plurality of points in the series of points.

20. A method comprising:
providing, by an optical transmitter, a beam of a transmitted optical wave scanned over a series of points arranged over a region;
receiving, by an optical receiver, backscattered portions of the transmitted optical wave and determine measurements associated with the backscattered portions of the transmitted optical wave for each of a plurality of the series of points, wherein the measurements include measurements used to determine at least one computed range and at least one computed velocity; and
controlling, by a phase modulation controller, modulation of a phase of the transmitted optical wave, where the modulation of the phase of the transmitted optical wave includes, for each of a plurality of the points in the series of points:
a first time period in which there is a constant phase, and
a second time period in which there is a non-constant phase modulated between at least two different phases.

21. The method of claim 20, wherein, for each of the plurality of the points in the series of points, an amplitude of the transmitted optical wave is constant during the second time period in which there is a non-constant phase modulated between at least two different phases.

22. The method of claim 21, wherein an amplitude of the transmitted optical wave is constant over an entire time period over all of the plurality of points in the series of points.

23. An apparatus comprising:
an optical transmitter configured to provide a beam of a transmitted optical wave scanned over a series of points arranged over a region, where the scanning over the series of points is repeated for each of a plurality of frames;
an optical receiver configured to receive backscattered portions of the transmitted optical wave and determine measurements associated with the backscattered portions of the transmitted optical wave for each of a plurality of the series of points for each of a plurality of the plurality of frames;
a modulation controller configured to control modulation of the transmitted optical wave; and
a computing module configured to compute at least one computed range and at least one computed velocity based at least in part on measurements associated with the backscattered portions of the transmitted optical wave, where the computing comprises:
determining the computed velocity based at least in part on a frequency shift associated with a Doppler frequency measurement associated with a backscattered portion of the transmitted optical wave, and
determining the computed range based at least in part on a first matched filter that is based at least in part on (1) a portion of modulation applied by the modulation controller and (2) the frequency shift associated with the Doppler frequency measurement.

24. The apparatus of claim 23, wherein the modulation controller comprises a phase modulation controller configured to control modulation of a phase of the transmitted optical wave, and the portion of modulation applied by the modulation controller comprises a portion of phase modulation applied by the modulation controller.

25. The apparatus of claim 23, wherein the Doppler frequency measurement is determined at least in part by determining a Fourier transform of a first electrical signal associated with the backscattered portion of the transmitted optical wave.

26. The apparatus of claim 24, wherein the first electrical signal is associated with the backscattered portion of the transmitted optical wave during a first time period in which there is a constant phase.

27. The apparatus of claim 23, wherein the first matched filter is applied to a second electrical signal associated with the backscattered portion of the transmitted optical wave during a second time period in which there is a non-constant phase modulated between at least two different phases.

28. The apparatus of claim 23, wherein the Doppler frequency measurement is determined based at least in part on a second matched filter that is based at least in part on a Fourier transform of the portion of modulation applied by the modulation controller.

29. A method comprising:
providing, by an optical transmitter, a beam of a transmitted optical wave scanned over a series of points arranged over a region, where the scanning over the series of points is repeated for each of a plurality of frames;
receiving, by an optical receiver, backscattered portions of the transmitted optical wave and determine measurements associated with the backscattered portions of the transmitted optical wave for each of a plurality of the series of points for each of a plurality of the plurality of frames;
controlling, by a modulation controller, modulation of the transmitted optical wave; and
computing, by a computing module, at least one computed range and at least one computed velocity based at least in part on measurements associated with the backscattered portions of the transmitted optical wave, where the computing comprises:
determining the computed velocity based at least in part on a frequency shift associated with a Doppler frequency measurement associated with a backscattered portion of the transmitted optical wave, and
determining the computed range based at least in part on a first matched filter that is based at least in part on (1) a portion of modulation applied by the modulation controller and (2) the frequency shift associated with the Doppler frequency measurement.

30. The method of claim 29, wherein the modulation controller comprises a phase modulation controller configured to control modulation of a phase of the transmitted optical wave, and the portion of modulation applied by the modulation controller comprises a portion of phase modulation applied by the modulation controller.

31. The method of claim 29, wherein the Doppler frequency measurement is determined at least in part by determining a Fourier transform of a first electrical signal associated with the backscattered portion of the transmitted optical wave.

32. The method of claim 31, wherein the first electrical signal is associated with the backscattered portion of the transmitted optical wave during a first time period in which there is a constant phase.

33. The method of claim 29, wherein the first matched filter is applied to a second electrical signal associated with the backscattered portion of the transmitted optical wave during a second time period in which there is a non-constant phase modulated between at least two different phases.

34. The method of claim 29, wherein the Doppler frequency measurement is determined based at least in part on a second matched filter that is based at least in part on a Fourier transform of the portion of modulation applied by the modulation controller.

35. An apparatus comprising:
an optical transmitter configured to provide a beam of a transmitted optical wave scanned over a series of points arranged over a region, where the scanning over the series of points is repeated for each of a plurality of frames;
an optical receiver configured to receive backscattered portions of the transmitted optical wave and determine measurements associated with the backscattered portions of the transmitted optical wave for each of a plurality of the series of points for each of a plurality of the plurality of frames;
a modulation controller configured to control modulation of the transmitted optical wave; and
a computing module configured to compute at least one computed range and at least one computed velocity based at least in part on measurements associated with the backscattered portions of the transmitted optical wave, where the computing comprises:
determining the computed velocity based at least in part on a first matched filter that is based at least in part on a frequency domain representation of a modulation applied by the modulation controller, and
determining the computed range based at least in part on a second matched filter that is based at least in part on a time domain representation of the modulation applied by the modulation controller.

36. The apparatus of claim 35, wherein the modulation controller comprises a phase modulation controller configured to control modulation of a phase of the transmitted optical wave.

37. A method comprising:
providing, by an optical transmitter, a beam of a transmitted optical wave scanned over a series of points arranged over a region, where the scanning over the series of points is repeated for each of a plurality of frames;
receiving, by an optical receiver, backscattered portions of the transmitted optical wave and determine measurements associated with the backscattered portions of the transmitted optical wave for each of a plurality of the series of points for each of a plurality of the plurality of frames;
controlling, by a modulation controller, modulation of the transmitted optical wave; and
computing, by a computing module, at least one computed range and at least one computed velocity based at least in part on measurements associated with the backscattered portions of the transmitted optical wave, where the computing comprises:
determining the computed velocity based at least in part on a first matched filter that is based at least in part on a frequency domain representation of a modulation applied by the modulation controller, and
determining the computed range based at least in part on a second matched filter that is based at least in part on a time domain representation of the modulation applied by the modulation controller.

38. The apparatus of claim 37, wherein the modulation controller comprises a phase modulation controller configured to control modulation of a phase of the transmitted optical wave.

39. An apparatus comprising:
an optical transmitter configured to provide a beam of a transmitted optical wave scanned over a series of points arranged over a region;
an optical receiver configured to receive backscattered portions of the transmitted optical wave and determine measurements associated with the backscattered portions of the transmitted optical wave for each of a plurality of the series of points, wherein the measurements include a measured range and a measured velocity; and
a data combination module configured to determine at least one computed range and at least one computed velocity based at least in part on combining (1) first partial data derived from at least one measurement associated with at least one backscattered portion of the transmitted optical wave with (2) second partial data derived from a detector, where the detector comprises at least one of:
a camera configured to capture an image including at least a portion of the region; or
a radar configured to capture velocity measurements over at least a portion of the region.

40. The apparatus of claim 39, wherein the second partial data includes information associated with one or more points in the series of points.

41. The apparatus of claim 39, wherein the data combination module is further configured to determine one or more boundary points associated with a boundary of a target within the region and based at least in part on the second partial data.

42. The apparatus of claim 39, further comprising a frequency modulation controller configured to control modulation of a frequency of the transmitted optical wave, where the modulation of the frequency of the transmitted optical wave includes at least a first slope for each of a plurality of frequency sweeps associated with respective points in the series of points.

43. The apparatus of claim 42, where the modulation of the frequency of the transmitted optical wave includes a second slope, different from the first slope, for each of a plurality of frequency sweeps associated with one or more boundary points.

44. The apparatus of claim 43, where the one or more boundary points are associated with a boundary of a target within the region and based at least in part on the second partial data.

45. A method comprising:
providing, by an optical transmitter, a beam of a transmitted optical wave scanned over a series of points arranged over a region;
receiving, by an optical receiver, backscattered portions of the transmitted optical wave and determine measurements associated with the backscattered portions of the transmitted optical wave for each of a plurality of the series of points, wherein the measurements include a measured range and a measured velocity; and
determining, by a data combination module, at least one computed range and at least one computed velocity based at least in part on combining (1) first partial data derived from at least one measurement associated with at least one backscattered portion of the transmitted optical wave with (2) second partial data derived from a detector, where the detector comprises at least one of:
a camera configured to capture an image including at least a portion of the region; or
a radar configured to capture velocity measurements over at least a portion of the region.

46. The method of claim 45, wherein the second partial data includes information associated with one or more points in the series of points.

47. The method of claim 45, wherein the data combination module is further configured to determine one or more boundary points associated with a boundary of a target within the region and based at least in part on the second partial data.

48. The method of claim 45, further comprising a frequency modulation controller configured to control modulation of a frequency of the transmitted optical wave, where the modulation of the frequency of the transmitted optical wave includes at least a first slope for each of a plurality of frequency sweeps associated with respective points in the series of points.

49. The method of claim 48, where the modulation of the frequency of the transmitted optical wave includes a second slope, different from the first slope, for each of a plurality of frequency sweeps associated with one or more boundary points.

50. The method of claim 49, where the one or more boundary points are associated with a boundary of a target within the region and based at least in part on the second partial data.
